(19) United States
(12) Patent Application Publication
(10) Pub. No.: US 2002/0126811 A1
(43) Pub. Date: Sep. 12, 2002

(54) Method for setting up and charging for a telecommunications link

(76) Inventors: Alexander Aschir, Bangladore (IN); Mathias Gabrysch, Muenchen (DE)

Correspondence Address: Kevin R. Spivak, Morrison & Foerster LLP, Suite 5500, 2000 Pennsylvania Avenue, N.W., Washington, DC, 20006-1888, US

(21) Appl. No.: 10/082,352

(22) Filed: Feb. 26, 2002

(30) Foreign Application Priority Data
Feb. 27, 2001 (DE) 10110349.2

(51) Int. Cl. H04M 15/00

(52) U.S. Cl. 379/114.01

(57) ABSTRACT

The present invention relates to a method for setting up a telecommunications link, and charging for it on the basis of location, between a first telecommunications subscriber, in particular a mobile radio subscriber, who is in a particular location and a second telecommunications subscriber in a communications network, in which a preferential charge tariff is used for charging for the telecommunications link if the location of the first telecommunications subscriber belongs to a selection of locations which has been made, where set-up of the telecommunications link is controlled by an intelligent network, and information required for location-based charging is made available to the communications network from an external service logic unit via an open network interface.

### CLAIM FOR PRIORITY

This application claims priority to Application No. DE 10110349.2 which was published in the German language on Feb. 27, 2001.

### TECHNICAL FIELD OF THE INVENTION

The invention relates to a method for setting up a telecommunications link and charging for the link on the basis of location, and in particular, to setting up and charging for the link between a first telecommunications subscriber at a particular location and a second telecommunications subscriber in a communications network.

### BACKGROUND OF THE INVENTION

The generally fast-moving telecommunications market is characterized by regular changes. At the same time, increasing competition in the field of consumer goods results in an ever increasing need to distinguish oneself from one's competitors. Heretobefore, the telecommunications market and consumer goods (outside of mobile telephones) have little if any relationship. That is, use of, for example, a mobile telephone does not affect consumer goods, and vice versa. Bringing these two markets together could be favorable to both the consumer and the market.

### SUMMARY OF THE INVENTION

In one embodiment of the invention, there is a method for setting up and charging for a telecommunications link, between a first telecommunications subscriber in a location and a second telecommunications subscriber in a communications network. The method includes, for example, applying a preferential charge tariff for setting up the telecommunications link if the location of the first telecommunications subscriber belongs to a selection of locations, where set-up of the telecommunications link is controlled by an intelligent network, and providing information required for location-based charging to the communications network from an external service logic unit via an open network interface.

In another aspect of the invention, a preferential charge tariff is used for charging if one or more other selected conditions are satisfied.

In another aspect of the invention, the method includes interrogating a data store associated with the external service logic unit to determine whether the location of the first telecommunications subscriber belongs to the selection of locations.

In yet another aspect of the invention, the method includes interrogating data stores associated with the external service logic unit to determine whether the location of the first telecommunications subscriber belongs to the selection of locations and whether the other selected conditions are satisfied.

In another aspect of the invention, the information required for charge billing is recorded by the external service logic unit and is forwarded via the open network interface to a billing unit provided for charge billing in the communications network after the telecommunications link has been terminated.

In another aspect of the invention, the open network interface is a Parlay or an OSA API.

### BRIEF DESCRIPTION OF THE INVENTION

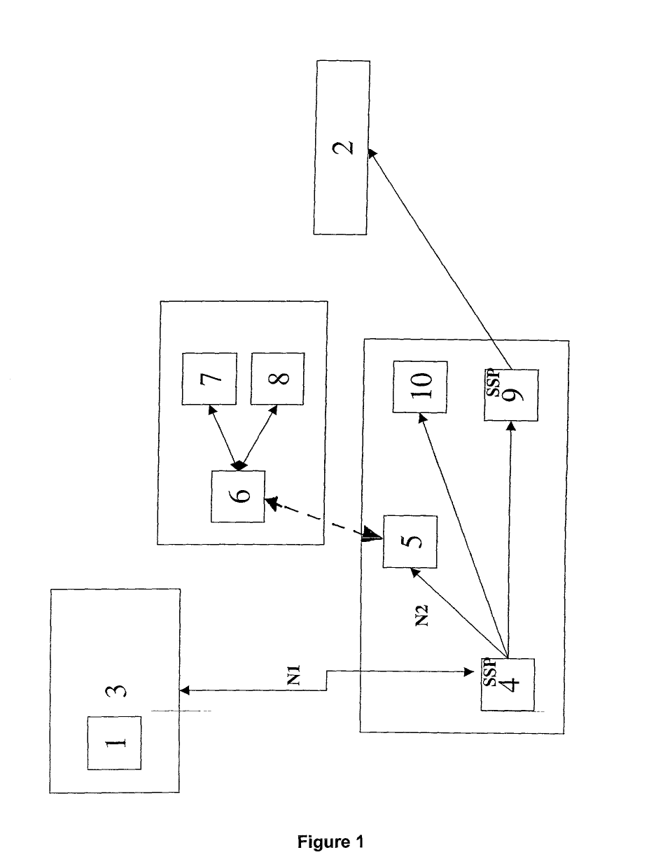

To explain the invention further, FIG. 1 shows an exemplary embodiment of a communications network for carrying out the invention.

### DETAILED DESCRIPTION OF THE PREFERRED EMBODIMENTS

The invention provides a method which can be adapted to altered conditions, which allows a non-network provider to give its customers in a communications network telecommunications links at a preferential charge tariff.

In one embodiment of the invention, there is a method for setting up a telecommunications link, and charging for the link on the basis of location, between a first telecommunications subscriber, in particular a mobile radio subscriber, who is in a particular location and a second telecommunications subscriber in a communications network, in which a preferential charge tariff is used for charging for the telecommunications link if the location of the first telecommunications subscriber belongs to a selection of locations which has been made, where set-up of the telecommunications link is controlled by an intelligent network (IN), and information required for location-based charging is made available to the communications network from an external service logic unit via an open network interface.

An intelligent network includes, for example, an intelligent node which monitors and controls the operations in this network. A fundamental prerequisite for the operation of an intelligent network is very high-performance exchange of information between the network nodes and a large central database including global network information which can be accessed quickly by any point in the network. Generally, the services are activated by particular service identification numbers or particular events. In this case, the service identification numbers do not address a switching centre or terminating equipment in the network, but rather activate the service providers in the network, i.e. the identification number calls a particular service. The call number which then ensues is transferred to an IN computer which is connected to the network externally and evaluates the call number as appropriate in the service called. Then, the setting information sent to the network and the two communication parties are connected to one another. The information for ascertaining the current service destination is stored in the IN computer in databases for each service and service customer. This structure requires global administration of businesses, which has to date been the task of the network operator. Only the network operator typically has control over network resources and the associated functionalities. IN-based value-added services require access to and control of network elements and network functions, and for this reason are provided directly only by network operators themselves.

The service provided by the inventive method comprises charging for a telecommunications link on the basis of location. The inventive method makes it possible for the information required for charging on the basis of location not to need to be obtained from a large, central database on an IN computer managed by the network operator, but rather for it to be provided by an external service logic unit via an open network interface. IN hardware generally comprises switching centers in the telephone network, so-called Service Switching Points (SSP), which detect the actual call to an IN service and route it to an appropriate Service Control Point (SCP). An IN service can, as already mentioned, be detected using appropriate service identification numbers or on the basis of particular events. The service itself runs in the SCP, a high-performance computer with a large, complex database. The SSP is a digital switching center including special control programs. The call to an IN service is coupled to an appropriately predefined trigger in the switching center's control. At this trigger point, the IN service starts. In this case, by way of example, the signalling is routed to the SCP which has stored the information required for evaluating the IN service and, following evaluation, returns appropriate setting information to the network. According to the invention, the information required for charging on the basis of location is now taken from an external, individual computer which can be coupled to the network via an open network interface.

The development and employment of open network interfaces allows network resources also to be used for private providers of value-added services which are not network operators. Preferably, the open network interface is an API (Application Programming Interface) defined by the Parlay group, referred to below as Parlay API, or a standardized OSA API. Whereas the Parlay API is predominantly used in the landline network sector, the OSA API is preferably used in mobile radio networks. The inventive method is of great interest, for example, to a department store chain. It provides the store with the opportunity to grant its customers, in particular mobile radio subscribers, one or more free or reduced-cost telephone calls on the basis of the customers' location, for example while they are in a branch of the department store chain. In this case, the call costs incurred are borne by the department store chain itself, for example. This gives the service provider, such as the aforementioned department store chain, a series of advantages. First, the customer is prompted to visit the department store chain, in which case, besides the free or reduced-cost telephoning granted to him, there is a certain degree of likelihood that he will notice the goods sold by the department store chain and may be tempted to buy one or other of them. Secondly, announcing the service in the appropriate media is certain to bring about increased awareness in the population. This is certain to result in a significant increase in sales, since more potential customers are visiting the department store chain. Overall, a higher degree of customer satisfaction is achieved which is ultimately also certain to result in increased awareness in the population by word of mouth. This results in increased customer loyalty. For the customer of the department store chain himself, it naturally has the advantage that he is able to telephone for free. The opportunity to exchange views and advice with another party by telephone, preferably by mobile radio, for example about a potential product for purchase, is significantly simplified by virtue of this. The customer has fewer inhibitions about obtaining the advice of someone who is not present by telephone, which he may forego for reasons of cost if he does not have this service granted to him by the department store chain, and may then also refrain from buying the product in question. There are also advantages for the network operators. The opportunity for non-network operators to access network resources via an open network interface and hence to be able to provide IN services directly themselves is certain to result in significant increases in sales for the network operators as well. In addition, the preferential charge tariff will certainly result in an increased volume of calls, which ultimately also increases the sales of the network operators.

In one preferred embodiment of the inventive method, a preferential charge tariff is used for charging if the location of the first telecommunications subscriber, in particular of the mobile radio subscriber, belongs to a selection of locations which has been made and at the same time one or more other selected conditions are satisfied.

In the case of the department store chain, it would be possible, for example, to link the cheap telephone call to the number of visits to a branch of the department store chain within a particular time interval. It would also be possible to make cheap telephoning dependent on sales generated by the customer. Furthermore, limits could be introduced such that a customer is able to make only one free or cheap telephone call per day.

In another aspect of the invention, advertising measures for the department store chain may be combined with cheap telephoning at the same time. By way of example, the sponsor could be named before the respective telephone call, or announcements relating to special offers by the department store chain could be played during or immediately prior to the telephone call.

In another preferred embodiment of the inventive method, a data store associated with the external service logic unit is interrogated to determine whether the location of the first telecommunications subscriber belongs to the selection of locations. In addition, preferably, other selected data for the first telecommunications subscriber is also transferred to such a data store and can be used, by way of example, to establish whether other selected conditions are also satisfied in order to be able to grant cheap telephoning.

In still another preferred embodiment of the inventive method, the information required for charge billing is recorded by the external service logic unit and is forwarded via the open network interface to a billing unit provided for charge billing in the communications network after the telecommunications link has been terminated.

In this embodiment, charges may be billed after the end of the telecommunications link in each case and, at the end of a particular period (e.g. at the end of the month), to produce a total bill for all of the charges which have been incurred in this period. Immediately after the telephone call, it is stipulated to whom the charges need to be billed, namely the department store chain if the selected conditions are satisfied, and otherwise the appropriate telecommunications subscriber himself. This allows the traditional type of charge billing in which, by way of example, an invoice for the charges incurred is produced at the end of each period.

In an example of the invention, a first telecommunications subscriber 1 in a communications network, preferably in a mobile radio network, is linked via a telecommunications link to a second telecommunications subscriber 2. The first telecommunications subscriber 1 is at a particular location 3, for example in a branch of a department store chain, as shown in the present case. The first telecommunications subscriber 1 dials a special service code and then the number of the second telecommunications subscriber 2 whom he wishes to telephone free, or at least at reduced cost. The special service number could, by way of example, be communicated in the appropriate branches of the department store chain. This could be done, by way of example, by means of appropriate announcements, by means of brochures or for all mobile radio subscribers by means of SMS. When the requested telecommunications link is first set up, a message N1 is sent from the first telecommunications subscriber 1 to a service switching point 4 (SSP) in the communications network. The service switching point 4 recognises that the special service number is an IN number, i.e. a number for calling an IN service. The service switching point SSP 4 then sends a message N2 to an IN station 5 responsible for this IN number, in the present case to a gateway which uses an open network interface, for example uses a Parlay API (Application Programming Interface) or an OSA API, to communicate with a computer 6 (Parlay or OSA client). The gateway 5 associates the IN number with an appropriate computer or a client 6 and uses the open network interface to notify the latter about the event which has occurred. The client 6 is located outside the network, in the present case as a service provider in the department store chain. This is where the actual service logic is executed. The client 6 then uses an interrogation message to interrogate appropriate data stores 7, 8 for information regarding whether the location 3 of the first telecommunications subscriber 1 belongs to the selection of locations which has been made, i.e. whether he is in a branch of the department store chain and also whether he satisfies one or more other selected conditions, for example whether he has generated a particular level of sales. The data stores 7, 8 return appropriate response messages to the client 6 and notify the latter that the first telecommunications subscriber 1 is both in a branch of the department store chain and has generated an appropriate level of sales. The client 6 then uses the gateway 5 to send a connection message and possibly a charging message to the SSP 4. All the messages sent by the gateway 5 to the SSP 4 are defined within the context of the so-called Intelligent Network Application Part (INAP), the Camel Application Part (CAP) or the Mobile Application Part (MAP). In this case, the connection message is a CON message, for example. The messages sent by the client 6 to the gateway 5 and vice versa are methods specified as appropriate by the Parlay group or by the OSA. In this case, the API maps the appropriate INAP, CAP or MAP messages exactly onto the appropriately defined, newly specified messages. By way of example, a CON message is mapped onto a “Route Request” message.

On the basis of the connection message, the SSP 4 sets up the telecommunications link between the first telecommunications subscriber 1 and the second telecommunications subscriber 2 via a further SSP 9. In another embodiment, the connection could also be set up via the same SSP 4.

Charging for the telecommunications link can be effected on the basis of the charging methods customary in telecommunications networks.

What is claimed is:

1. A method for setting up and charging for a telecommunications link, between a first telecommunications subscriber in a location and a second telecommunications subscriber in a communications network, comprising:
applying a preferential charge tariff for setting up the telecommunications link if the location of the first telecommunications subscriber belongs to a selection of locations, where set-up of the telecommunications link is controlled by an intelligent network; and
providing information required for location-based charging to the communications network from an external service logic unit via an open network interface.

2. The method as claimed in claim 1, wherein a preferential charge tariff is used for charging if one or more other selected conditions are satisfied.

3. The method as claimed in claim 1, further comprising:
interrogating a data store associated with the external service logic unit to determine whether the location of the first telecommunications subscriber belongs to the selection of locations.

4. The method as claimed in claim 2, further comprising:
interrogating data stores associated with the external service logic unit to determine whether the location of the first telecommunications subscriber belongs to the selection of locations and whether the other selected conditions are satisfied.

5. The method as claimed in claim 1, wherein the information required for charge billing is recorded by the external service logic unit and is forwarded via the open network interface to a billing unit provided for charge billing in the communications network after the telecommunications link has been terminated.

6. The method as claimed in claim 1, wherein in that the open network interface is a Parlay or an OSA API.
